(19) United States
(12) Patent Application Publication
(10) Pub. No.: US 2019/0159429 A1
(43) Pub. Date: May 30, 2019

(54) SOCK AND GLOVE PET MASSAGE DEVICES

(71) Applicant: Jessica Eveningred, Bisbee, AZ (US)

(72) Inventor: Jessica Eveningred, Bisbee, AZ (US)

(21) Appl. No.: 15/822,216

(22) Filed: Nov. 27, 2017

(51) Int. Cl. A01K 13/00; A41B 11/00; A41D 19/00

(52) U.S. Cl. CPC A01K 13/00; A41D 19/0082; A41B 11/004; A41B 11/008

(57) ABSTRACT

A pet massage sock, including an opening to receive a foot of a user, and a rubber nub portion disposed on at least a portion of the pet massage sock. Also, a pet massage glove, including an opening to receive a hand of a user, and a rubber nub portion disposed on at least a portion of the pet massage glove.

### BACKGROUND OF THE INVENTION

### 1. Field of the Invention

The present general inventive concept relates generally to pet massage devices, and more specifically, to sock and glove pet massage devices.

### 2. Description of the Related Art

Pet owners love their animals wholeheartedly, and often spend many hours each week massaging their beloved pets. However, human fingernails are often not enough to give animals the satisfaction they desire from a massage.

Moreover, when owners who are allergic to animals rub their pets with their bare hands, they experience uncomfortable allergic reactions. When these allergic pet owners put on rubber gloves to rub their pets, the pets do not get a good massage due to the uncomfortable material of the gloves.

Therefore, there is a need for sock and glove devices that provide superior massages for pets.

There is also a need for sock and glove devices that protect allergic pet owners from rubbing their pets with bare hands, while still providing a superior massage for the pets.

### SUMMARY

The present general inventive concept provides sock and glove pet massage devices.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a pet massage sock, including an opening to receive a foot of a user, and a rubber nub portion disposed on at least a portion of the pet massage sock.

The rubber nub portion may include a plurality of small circular rubber nubs.

The rubber nub portion may be disposed on at least one of a sole of the pet massage sock and a top portion of the pet massage sock.

The pet massage sock may further include a big toe portion to receive a big toe of the user, a pointer toe portion to receive a pointer toe of the user, a middle toe portion to receive a middle toe of the user, a ring toe portion to receive a ring toe of the user, and a pinky toe portion to receive a pinky toe of the user.

The foregoing and/or other features and utilities of the present general inventive concept may also be achieved by providing a pet massage glove, including an opening to receive a hand of a user, and a rubber nub portion disposed on at least a portion of the pet massage glove.

The rubber nub portion may include a plurality of small circular rubber nubs.

The rubber nub portion may be disposed on at least one of a palm portion of the pet massage glove and a back portion of the pet massage glove.

The pet massage glove may further include a thumb portion to receive a thumb of the user, a pointer finger portion to receive a pointer finger of the user, a middle finger portion to receive a middle finger of the user, a ring finger portion to receive a ring finger of the user, and a pinky finger portion to receive a pinky finger of the user.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a pet massage sock, according to an exemplary embodiment of the present general inventive concept;

FIG. 2 illustrates a pet massage sock, according to another exemplary embodiment of the present general inventive concept;

FIG. 3A illustrates a palm portion of a pet massage glove, according to an exemplary embodiment of the present general inventive concept; and

FIG. 3B illustrates a back portion of a pet massage glove, according to an exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

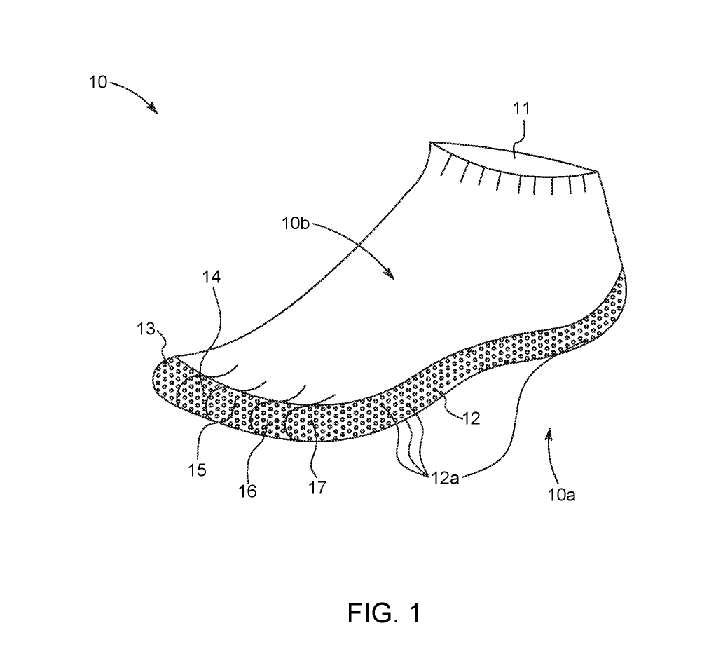

FIG. 1 illustrates a pet massage sock 10, according to an exemplary embodiment of the present general inventive concept.

The pet massage sock 10 may be made from cotton, cloth, polyester, wool, rubber, or any other type of flexible material.

Referring to FIG. 1, the pet massage sock 10 may include an opening 11 and a rubber nub portion 12.

A user may insert a foot into the opening 11 in order to wear the pet massage sock 10.

The rubber nub portion 12 may be disposed on at least a portion of a sole 10a of the pet massage sock 10, as well as at least a portion of a top 10b of the pet massage sock 10. The rubber nub portion 12 may include a plurality of small circular rubber nubs 12a that provide massage relief to a pet when the pet is rubbed with the rubber nub portion 12. The plurality of small circular rubber nubs 12a may alternatively be made from plastic or other massaging material, and may have pyramidal shapes or any other shapes different from circles.

The rubber nub portion 12 may include a big toe portion 13, a pointer toe portion 14, a middle toe portion 15, a ring toe portion 16, and a pinky toe portion 17.

When the user inserts the foot into the opening 11 of the pet massage sock 10, the user may continue to insert the foot into the pet massage sock 10 until a big toe of the user enters the big toe portion 13, a pointer toe of the user enters the pointer toe portion 14, a middle toe of the user enters the middle toe portion 15, a ring toe of the user enters the ring toe portion 16, and a pinky toe of the user enters the pinky toe portion 17. As such, since the rubber nub portion 12 covers at least a portion of each of the big toe portion 13, the pointer toe portion 14, the middle toe portion 15, the ring toe portion 16, and the pinky toe portion 17, the user may have free movement of each of the user's toes to provide massage relief to the user's pet.

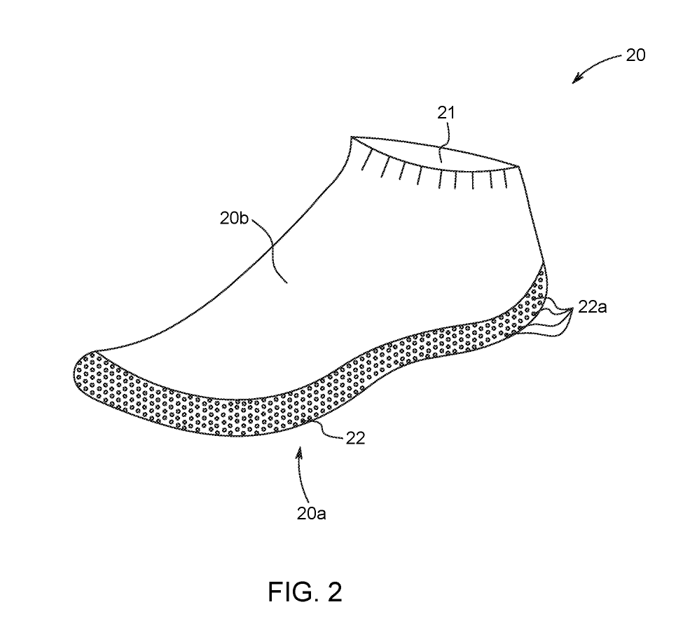

FIG. 2 illustrates a pet massage sock 20, according to another exemplary embodiment of the present general inventive concept.

The pet massage sock 20 may be made from cotton, cloth, polyester, wool, rubber, or any other type of flexible material.

Referring to FIG. 2, the pet massage sock 20 may include an opening 21 and a rubber nub portion 22.

A user may insert a foot into the opening 21 in order to wear the pet massage sock 20.

The rubber nub portion 22 may be disposed on at least a portion of a sole 20a of the pet massage sock 20, as well as at least a portion of a top 20b of the pet massage sock 20. The rubber nub portion 22 may include a plurality of small circular rubber nubs 22a that provide massage relief to a pet when the pet is rubbed with the rubber nub portion 22. The plurality of small circular rubber nubs 22a may alternatively be made from plastic or other massaging material, and may have pyramidal shapes or any other shapes different from circles.

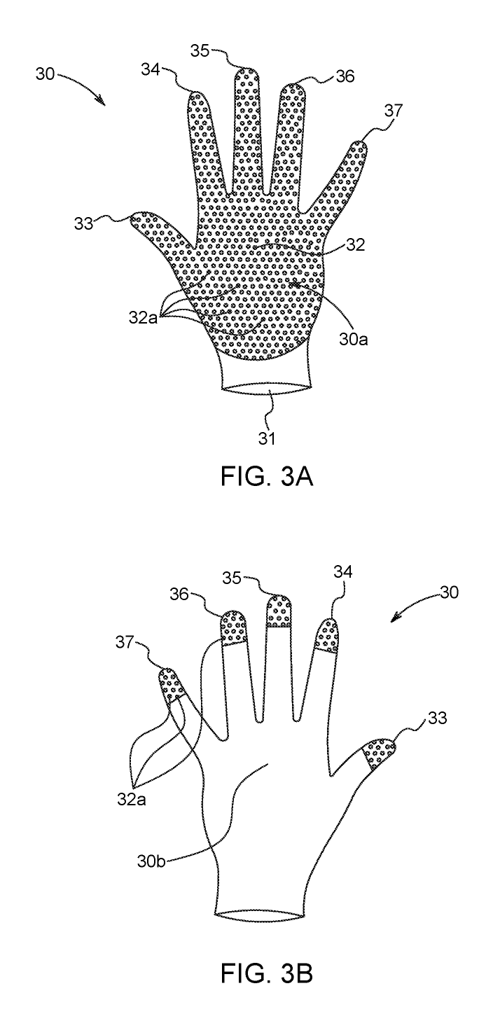

FIG. 3A illustrates a palm portion 30a of a pet massage glove 30, according to an exemplary embodiment of the present general inventive concept.

FIG. 3B illustrates a back portion 30b of the pet massage glove 30, according to an exemplary embodiment of the present general inventive concept.

Referring to FIGS. 3A and 3B, the pet massage glove 30 may include an opening 31 and a rubber nub portion 32.

The pet massage glove 30 may be made from cotton, cloth, polyester, wool, rubber, or any other type of flexible material.

A user may insert a hand into the opening 31 in order to wear the pet massage glove 30.

The rubber nub portion 32 may be disposed on at least a portion of the palm portion 30a of the pet massage glove 30, as well as on at least a portion of the back portion 30b of the pet massage glove 30. The rubber nub portion 32 may include a plurality of small circular rubber nubs 32a that provide massage relief to a pet when the pet is rubbed with the rubber nub portion 32. The plurality of small circular rubber nubs 32a may alternatively be made from plastic or other massaging material, and may have pyramidal shapes or any other shapes different from circles.

The rubber nub portion 32 may include a thumb portion 33, a pointer finger portion 34, a middle finger portion 35, a ring finger portion 36, and a pinky finger portion 37.

When the user inserts the hand into the opening 31 of the pet massage sock 30, the user may continue to insert the hand into the pet massage sock 30 until a thumb of the user enters the thumb portion 33, a pointer finger of the user enters the pointer finger portion 34, a middle finger of the user enters the middle finger portion 35, a ring finger of the user enters the ring finger portion 36, and a pinky finger of the user enters the pinky finger portion 37. As such, since the rubber nub portion 32 covers at least a portion of each of the thumb portion 33, the pointer finger portion 34, the middle finger portion 35, the ring finger portion 36, and the pinky finger portion 37, the user may have free movement of each of the user's fingers to provide massage relief to the user's pet.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A pet massage sock, comprising:
an opening to receive a foot of a user;
a rubber nub portion disposed on at least a portion of the pet massage sock.

2. The pet massage sock of claim 1, wherein the rubber nub portion comprises a plurality of small circular rubber nubs.

3. The pet massage sock of claim 1, wherein the rubber nub portion is disposed on at least one of a sole of the pet massage sock and a top portion of the pet massage sock.

4. The pet massage sock of claim 1, further comprising:
a big toe portion to receive a big toe of the user;
a pointer toe portion to receive a pointer toe of the user;
a middle toe portion to receive a middle toe of the user;
a ring toe portion to receive a ring toe of the user; and
a pinky toe portion to receive a pinky toe of the user.

5. A pet massage glove, comprising:
an opening to receive a hand of a user;
a rubber nub portion disposed on at least a portion of the pet massage glove.

6. The pet massage glove of claim 1, wherein the rubber nub portion comprises a plurality of small circular rubber nubs.

7. The pet massage sock of claim 1, wherein the rubber nub portion is disposed on at least one of a palm portion of the pet massage glove and a back portion of the pet massage glove.

8. The pet massage glove of claim 1, further comprising:
a thumb portion to receive a thumb of the user;
a pointer finger portion to receive a pointer finger of the user;
a middle finger portion to receive a middle finger of the user;
a ring finger portion to receive a ring finger of the user; and
a pinky finger portion to receive a pinky finger of the user.
